(19) United States
(12) Patent Application Publication
(10) Pub. No.: US 2020/0261749 A1
(43) Pub. Date: Aug. 20, 2020

(54) AIR PURIFIER WITH INTEGRATED AIR FILTERING MASK

(71) Applicant: Yung-Jen CHEN, Kaohsiung City (TW)

(72) Inventor: Yung-Jen CHEN, Kaohsiung City (TW)

(21) Appl. No.: 16/789,437

(22) Filed: Feb. 13, 2020

(30) Foreign Application Priority Data
Feb. 15, 2019 (TW) 108105201
Feb. 15, 2019 (TW) 108202023

(51) Int. Cl. A62B 23/02; A62B 7/10

(52) U.S. Cl. CPC A62B 23/02; B01D 46/0002; A62B 7/10

(57) ABSTRACT

An air purifier with an integrated air filtering mask includes a housing having a housing-base and a housing-body. The housing-base is provided with a filter-tube coupling portion and a plurality of air inlet holes around the filter-tube coupling portion. The housing-body is provided with a fan receiving slot and a plurality of air owlet boles passing through the fan receiving slot. A fan is disposed in the fan receiving slot. A casing has'a mask and a conduit. The mask is detachably coupled with the fan receiving slot, and is provided a circulation port and a window. A first port of the conduit is detachably coupled with the filter-tube coupling portion of the housing. A second port of the conduit communicates with the circulation port of the mask. An air filter is disposed at the first port of the conduit.

### CROSS REFERENCE TO RELATED APPLICATIONS

This application claims the priority of Taiwan Patent Applications No. 108105201 and No. 108202023, both titled as “AIR. PURIFIER WITH INTEGRATED AIR FILTERING MASK”, both filed on Feb. 15, 2019, the disclosures of which are incorporated herein by reference.

### FIELD OF THE INVENTION

The present disclosure relates to the technical field of air purifiers, and specifically to an air purifier with an integrated air filtering mask.

### BACKGROUND OF THE INVENTION

According to some statistical results, nearly 80% of the final causes of fires is used by thick smoke rather than direct exposure to flames, Most of the causes of death in a fired environment are inhalation of poisonous gases resulting in suffocation and coma.

For example, when the flame burns items, such as furniture, toxic gases are generated resulting in very high concentrations of the toxic oases in the thick smoke in the fired environment, especially carbon monoxide, which will quickly combine with red blood cells after entering the human body, making the blood unable to deliver oxygen, causing the human body to die of hypoxia.

However, disaster prevention awareness has not been deeply rooted in people's hearts. Even if the fire department has worked hard to publicize, people preparing smoke masks at home are few. Even if they prepare the smoke masks, the masks are rarely readily available. The reason is that the smoke masks are not a decoration at home. If the smoke mask is placed in an obvious place, the place will be too obtrusive and unsightly. Therefore, most people do not use the smoke mask during a fire because of tension or forgetting a storage location of the smoke mask.

In view of the above case, it is necessary to provide a technical solution different from the past, in order to solve a problem existing in the prior art.

### SUMMARY OF THE INVENTION

An object of the present disclosure is to provide an air purifier with an integrated air filtering mask, which integrates an air filtering mask into a part of a housing of the air purifier, so as to prepare the air filtering mask in a place where the air purifier is disposed, thereby improving success rate of escaping from tire and smoke.

In order to achieve the above object, the present disclosure provides an air purifier with an integrated air filtering mask, which includes a housing having a housing-base and a housing-body, wherein the housing-base is provided with a filter-tube coupling portion and a plurality of air inlet holes around the filter-tube coupling portion, and the housing-body is provided with a fan receiving slot and a plurality of air outlet holes passing through the fan receiving slot; a fan disposed in the fan receiving slot; a casing having a mask and a conduit, wherein the mask is detachably coupled with the fan receiving slot, the mask is provided with a circulation port and a window, a first port of the conduit is detachably coupled with the filter-tube coupling portion of the housing, and a second port of the conduit communicates with the circulation port of the mask; and an air filter disposed at the first port of the conduit.

In an embodiment of the present disclosure, a first edge of the mask and a second edge of the fan receiving slot are jointly formed into a snap-fit structure.

In an embodiment of the present disclosure, a first edge of the mask and a second edge of the fan receiving slot are jointly formed into a matching structure.

In an embodiment of the present disclosure, a first edge of the mask and a second edge of the fan receiving slot are jointly formed into a zippered structure.

In an embodiment of the present disclosure, a human-fare adapter is provided on a first edge of the mask.

In an embodiment of the present disclosure, the human-face adapter is a clasping-strip assembly.

In an embodiment of the present disclosure, the filter-tube coupling portion is formed into a filter-tube coupling cylinder, and a cylindrical wall of the filter-tube coupling cylinder is provided with a plurality of air-guiding holes.

In an embodiment of the present disclosure, the casing is provided with an escape warning element and a power supply module, the escape warning element is located around the window, and the power supply module is electrically connected to the escape warning element.

In an embodiment of the present disclosure, the power supply module is a photovoltaic battery pack.

In an embodiment of the present disclosure, the escape warning element is selected from a group consisting of an emergency lighting unit, a sounder, a radio transmitter and a global positioning system.

The air purifier with the integrated air filtering mask of the above embodiments of the present disclosure can be a part of decorations in an environment (such as a living room in the home, a room, or a workplace), and can be placed. in a place where people can get. The air purifier with the, integrated air filtering mask not only provides the air purifying function, but also improves the problem that the existing smoke mask is placed in a place where people cannot get the mask. Therefore, under the condition of casualties during a fire caused by no smoke mask available, the above embodiments, of the present disclosure are advantageous for reducing a number of casualties at the time of public hazards (such as, fire disasters). If the smoke mask. further becomes the content of relevant standards for household appliances, a number of casualties at public hazards (such as, fire disasters) can be further reduced, which is, beneficial to protect the personal safety.

### BRIEF DESCRIPTION OF THE DRAWINGS

FIG. 1 is an exploded perspective view of an air purifier with the integrated air filtering mask, according to an embodiment of the present disclosure.

FIG. 2 is a combined perspective view of a part of the air cleaner with the integrated air filter mask according to the embodiment of the present disclosure.

FIG. 3 is a combined perspective view of another part of the air cleaner with tie integrated air filter mask according to the embodiment of the present disclosure.

### THE DETAILED DESCRIPTION OF PREFERRED EMBOINMENTS

The following description of the various embodiments is provided to illustrate the specific, embodiments of the present disclosure. Furthermore, directional terms mentioned in the present disclosure, such as upper, lower, top, bottom, front, rear, left, right, inner, outer, side, surrounding, central, horizontal, lateral, vertical, longitudinal, axial, radial, uppermost layer or lowermost layer, which only refer to the direction of drawings. Therefore, the directional terms configured as above are for a purpose of illustration and understanding of the present disclosure, and are not, intended to limit the present disclosure.

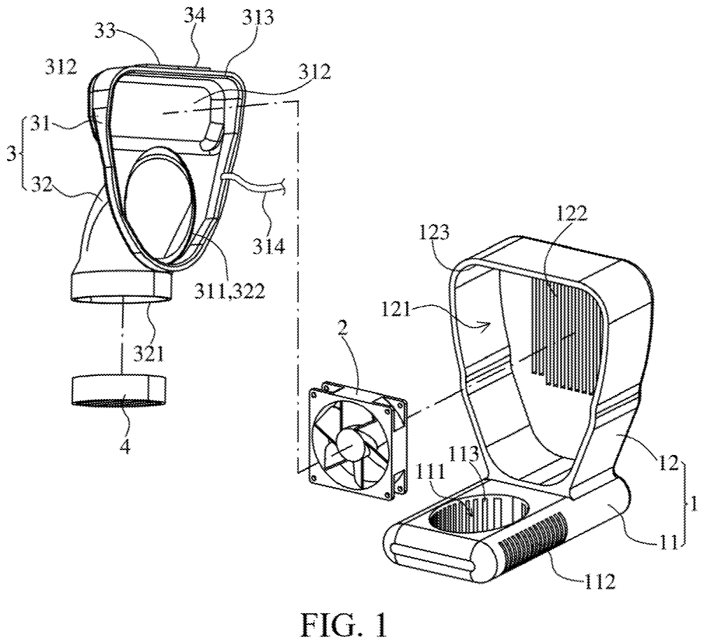

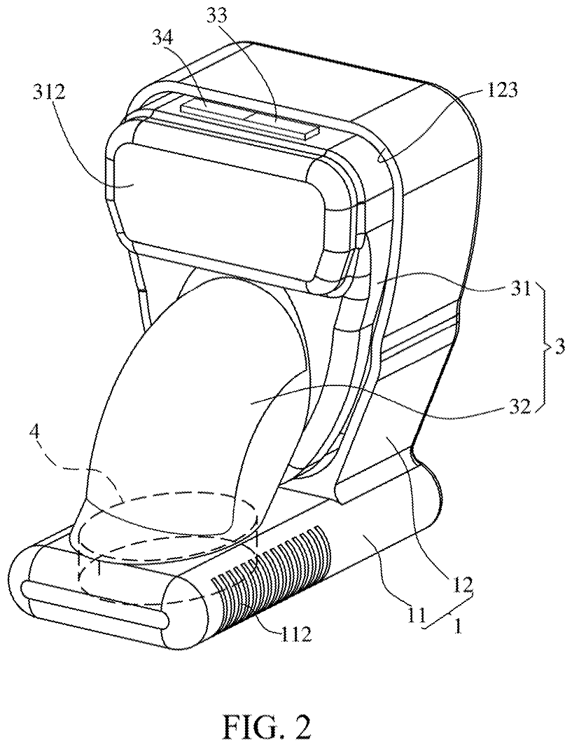

Please refer to FIGS. 1 and 2, an air purifier with an integrated air filtering mask provided by an embodiment of the present disclosure includes a housing 1, a fan 2, a casing 3, and an air filter 4. The housing 1 and the casing 3 may be jointly formed into a shell of the air purifier with the integrated air filtering mask. The fan 2 and the air filter 4 are disposed in the shell, which is jointly formed of the housing 1 and the casing 3. The fan 2 and the air filter 4 are configured to generate airflow and filter air, respectively. Examples of the air purifier with the integrated air filtering mask are illustrated as follows, but are not limited thereto.

For example, as shown in FIGS. 1 and 2, the housing 1 may be made of a hard material, for example, molded from plastic, etc. The housing 1 may have a housing-base 11 and a housing-body 12. The housing base 11 is provided with a filter-tube coupling portion 111 and a plurality of air inlet holes 112, which may be located around the filter-tube coupling portion 111. For example, the air inlet holes 112 may be a plurality of circular holes or strip-shaped holes passing through the housing-base 11, in order to inhale external air for filtering. The housing-body 12 may be provided with a tars receiving slot 121 and a plurality of air outlet holes 122 passing through the fan receiving slot 121. For example, the air outlet holes 122 may be a plurality of circular holes or strip-shaped holes passing through the housing-base 11, in order to exhaust filtered airflow.

In an embodiment, as shown in FIG. 1, the filter-tube coupling portion 111 may be formed into a filter-tube coupling cylinder, which is configured to provide an auxiliary fixation effect. Optionally, a cylindrical wall of the filter-tube coupling cylinder is provided with a plurality of air-guiding holes 113, which are configured to assist the circulation of air.

As shown in FIG. 2, the fan 2 may be an AC fan or a DC fan. The fan 2 may be disposed in the fan receiving slot 121 for energizing and driving air flow. The fan 2 may be an axial fan, a blower, or another fan. Herein, an axial fan is taken as an example. The air outlet holes 122 are correspondingly provided on a back plate portion of the housing-body 12 (taking the drawing as an example). Alternatively, if the fan 2 is a blower, the air outlet holes 122 may be correspondingly provided on a side wall portion of the housing-body 12 (take the drawing as an example), but are not limited thereto.

As shown in FIGS. 1 and 2, the casing 3 may have a mask 31 and a conduit 32. The mask 31 may be made of plastic. The mask 31 may be detachably coupled to the Fan receiving slot 121. The mask 31 may also be provided with a circulation port 311 and a window 312. The circulation port 311 can be configured for air circulation. The window 312 may be made of transparent hard materials, such as transparent acrylic or glass, which can be used for users to view objects through the window 312. Two ends of the conduit 32 may be formed of plastic. A first port 321 of the conduit 32 is detachably coupled with the filter-tube coupling portion 111 of the housing 1, and a second port 322 of the conduit 32 communicates with the circulation port 311 of the mask 31, in which the airflow is directed to the circulation port 311 of the mask 31.

As shown in FIGS. 1 and 2, the air filter 4 may be made of a material suitable for filtering air pollution, such as High-Efficiency Particulate Air (HEPA). The air filter 4 may he disposed at an appropriate position of an air flow path between the air inlet holes 112 and the air outlet holes 122. For example, the air filter 4 may be disposed at the first port 321 of the conduit 32 to filter the air flowing in through the air inlet holes 112.

As shown in FIGS. 1 and 2, the above embodiments of the air purifier with the integrated air filtering mask has two usage modes, which are a purifier mode (as shown in FIG. 2) and a mask mode (as shown in 1).

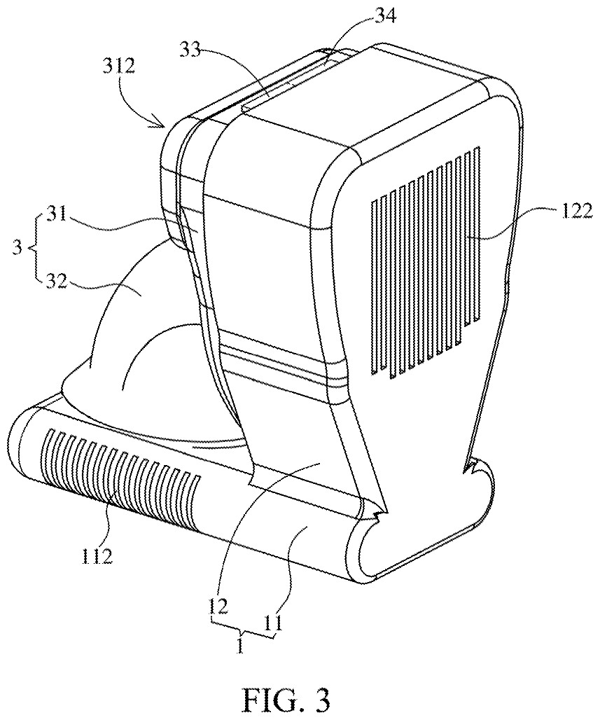

For example, before the above embodiments as used in the purifier mode, as shown in FIG. 1, the housing 1, the fan 2, the casing 3, and the air filter 4 can be assembled as described above (as shown in FIGS. 2 and 3). For example, the fan 2 can be assembled in the housing 1, the air filter 4 can be assembled in the casing 3, and the housing 1 and the casing 3 can be coupled to each other, by the supplier or the user. For example, the first port 321 of the conduit 32 is installed in the filter-tube coupling portion 111 of the housing 1, and the mask 31 is installed in the fan receiving slot 121.

Optionally, the housing 1 and the casing 3 may be designed to be easily detachable. For example, a first edge 313 of the mask 31 and a second edge 123 of the fan receiving slot 121 may be jointly formed into a snap-fit structure. For example, a dovetail-shaped groove and a tenon structure may be formed between the first edge 313 and the second edge 123, so as to fix and detach the mask 31 and the fan receiving, slot 121.

Alternatively, the first edge 313 of the mask 31 and the second edge 123 of the fan receiving slot 121 are jointly formed into a matching structure, so as to be detachably coupled. For example, hook-and-loop fasteners or buckled straps may be added between the first edge 313 and the second edge 123, so as to fix and detach the mask 31 and the fan receiving slot 121.

Alternatively, the first edge 313 of the mask 31 and the second edge 123 of the fan receiving slot 121 are jointly formed into a zippered structure, so as to be detachably coupled. For example, zippers may be added between the first edge 313 and the second edge 123, so as to fix and detach the mask 31 and the fan receiving slot 121.

In another aspect, as shown in FIG. 1, when the above embodiments are used in the, mask mode, a user can detach the casing 3 from the housing 1, in order to correspondingly fix the circulation port 311 and the window 312 of die mask 31 to the user's nose and eyes, so as to be used as an air-filtering mask. For example, a smoke-proof mask can be used as a life-saving device in emergency escape (such as fire or toxic gas leakage).

Optionally, as shown in FIG. 1, the first edge 313 of the mask 31 can be adapted to human facial characteristics to make appropriate changes. For example, the first edge 313 can be appropriately deformed or provided with an elastic material (such as Polymer materials that are softness suitable for a fired, environment), so as to fit the human face. The first edge 313 can also be provided with a human-face adapter 314, which is configured to match a contour or shape of the human face. For example: the human-face adapter 314 may be a, clasping-strip assembly, such as a meshed fastener, so as to securely fix the mask 31 on the user's head, in order to prevent the mask 31 from falling during use.

Additionally, as shown in FIG. 1, the casing 3 is further provided with an escape warning element 33 and a power supply module 34, in order to assist personnel in escape. For example, the escape warning element 33 may be located around the window. For example, the escape warning element 33 may be located above the window 312, but is not limited thereto. The escape warning element 33 may be selected from a group consisting of an emergency lighting unit, a sounder, a radio transmitter, and, a global positioning system, Specifically, the escape warning element 33 may be selected as one of the emergency lighting unit, the sounder, the radio transmitter, the global positioning system, and a combination thereof, according to actual needs. In this embodiment, an LED emergency lighting device is only taken as an example of the escape warning piece 33, but is not limited thereto. In addition, the power supply module 34 may be various types of batteries, such as a photovoltaic battery pack for charging and discharging. The power supply module 34 is electrically connected to the escape warning element 33, and is used to provide the power required for an operation of the escape warning element 33, so as to assist the user to escape in an emergency (such as a fire disaster).

The air purifier with the integrated air filtering mask in the above embodiments of the present disclosure can integrate an as mask into a part of the housing of the air purifier, so that the air-filtering mask is prepared in a place where the air purifier is disposed. In a general case, users can use a function of the air purifier to filter air pollution in the environment. In an emergency case (such as a fire or toxic gas leakage), users can directly detach the casing 3 from the housing 1, in order to use a function of the mask as a lifesaving device in a case of emergency escape (such as fire or toxic gas leakage).

The air purifier with the integrated air filtering mask of the above embodiments of the, present disclosure can be a part of decorations in an environment (such as a living room m the home, a room, or a workplace), and can be placed in a place where people can get. The air purifier with the integrated air filtering mask not only provides the air purifying function, but also improves the problem that the existing smoke mask is placed in a place where people cannot get the mask. Therefore, tinder the condition of casualties during a fire caused by no smoke mask available, the above embodiments of the present disclosure are advantageous for reducing a number of casualties at the time of public hazards (such as, fire disasters). If the smoke mask further becomes the content of relevant standards for household appliances, a number of casualties at public hazards (such as, fire disasters) can be further reduced, which is beneficial to protect the personal safety.

Although the present disclosure has been disclosed in preferred embodiments, which are not intended to limit the disclosure. Those skilled in the art can make Various changes and modifications without departing from the spirit and scope of the disclosure. Therefore, a scope of protection of the present disclosure is defined as definitions of the scope of the claims.

What is claimed is:

1. An air purifier with an integrated air filtering mask, comprising:
a housing having a housing-base and a housing-body, wherein the housing-base is provided with a filter-tube coupling portion and a plurality of air inlet holes around the filter-tube coupling portion, and the housing-body is provided with a fan receiving slot and a plurality of air outlet holes passing through the fan receiving slot:
a fan disposed in the fan receiving slot;
a casing having a mask and a conduit, wherein the mask is detachably coupled with the fan receiving slot, the mask is provided with a circulation port and a window, a first port of the conduit is detachably coupled with the filter-tube coupling portion of the housing, and a second port of the conduit communicates with the circulation port of the mask; and
an air filter disposed at the first port of the conduit.

2. The air purifier with the integrated air filtering mask as claimed in claim 1, wherein a first edge of the mask and a second edge of the fan receiving slot are jointly formed into a snap-fit structure.

3. The air purifier with the integrated air filtering mask as claimed in claim 1, wherein a first edge of the mask and a second edge of the fan receiving slot are jointly formed into a matching structure.

4. The air purifier with the integrated air filtering mask as claimed in claim 1, wherein a first edge of the mask and a second edge of the fan receiving slot are jointly formed into a zippered structure.

5. The air purifier with the integrated air filtering mask as claimed in claim 1. wherein a human -face adapter is provided on a first edge of the mask.

6. The air purifier with the integrated air filtering mask as claimed in claim 5, wherein the human-face adapter is a clasping-strip assembly.

7. The air purifier with the integrated air filtering mask as claimed in claim 1, wherein the filter-tube coupling portion is formed into a filter-tube coupling cylinder, and a cylindrical wall of the filter-tube coupling cylinder is provided with a plurality of air-guiding holes.

8. The air purifier with the integrated air filtering mask as claimed in claim 1, wherein the casing is provided with an escape warning element and a power supply module, the escape warning element is located around the window, and the power supply module is electrically connected to the escape warning element.

9. The an purifier with the integrated air filtering, mask as claimed in claim 8, wherein the power supply module is a photovoltaic battery pack,

10. The air purifier with the integrated air filtering mask as claimed in claim 8, wherein the escape warning element is selected from a group consisting of, an emergency lighting unit, a sounder, a radio, transmitter, and a global positioning system.
